(19) United States
(12) Patent Application Publication
(10) Pub. No.: US 2026/0238089 A1
(43) Pub. Date: Aug. 13, 2026

(54) ELECTRIC POWER TRANSMISSION DEVICE AND MOTOR APPARATUS

(71) Applicant: TDK CORPORATION, Tokyo (JP)

(72) Inventors: Kazuyoshi HANABUSA, Tokyo (JP); Yuki CHAI, Tokyo (JP)

(73) Assignee: TDK CORPORATION, Tokyo (JP)

(21) Appl. No.: 19/155,713

(22) PCT Filed: Feb. 14, 2023
(86) PCT No.: PCT/JP2023/004992

§ 371 Date: Aug. 12, 2025

(51) Int. Cl. H02K 11/042; H01F 38/18; H02K 11/33

(52) U.S. Cl. CPC H02K 11/042; H01F 38/18; H02K 11/33

(57) ABSTRACT

An electric power transmission device includes a magnetic core, a first winding, a rotary member, and a second winding. The magnetic core has a ring shape including a through hole through which a shaft extends. The magnetic core includes therein a cavity along a circumferential direction about an axis of rotation of the shaft, and has an opening to the cavity. The opening is provided along the circumferential direction in a surface of the magnetic core different from a surface thereof in contact with the through hole. The first winding is provided in the cavity and wound along the circumferential direction. The rotary member is coupled to the shaft through the opening, and rotationally movable, inside the cavity, in the circumferential direction with a rotation of the shaft. The second winding is provided on the rotary member and wound along the circumferential direction.

### TECHNICAL FIELD

The disclosure relates to an electric power transmission device that contactlessly transmits electric power, and to a motor apparatus including such an electric power transmission device.

### BACKGROUND ART

Examples of a motor include an electrically excited synchronous motor (EESM). Such a motor includes a stator on which a winding is wound and a rotor on which a winding is wound. In the motor, a current to be fed through the winding wound on the rotor may be varied in accordance with a rotation speed of the motor. This makes it possible to achieve improved efficiency of the motor.

Some devices allow for transmission of electric power between a stator and a rotor. For example, Patent Literature 1 discloses a rotary transformer that includes a stator on which a winding is wound and a rotor on which a winding is wound, and that allows for transmission of electric power between the stator and the rotor.

### Citation List

### Patent Literature

Patent Literature 1: Japanese Unexamined Patent Application Publication No. 2002-75760

### SUMMARY

An electric power transmission device according to one embodiment of the disclosure includes a magnetic core, a first winding, a rotary member, and a second winding. The magnetic core has a ring shape including a through hole through which a shaft extends. The magnetic core includes therein a cavity along a circumferential direction about an axis of rotation of the shaft, and has an opening to the cavity. The opening is provided along the circumferential direction in a surface of the magnetic core different from a surface thereof in contact with the through hole. The first winding is provided in the cavity and wound along the circumferential direction. The rotary member is coupled to the shaft through the opening, and is rotationally movable, inside the cavity, in the circumferential direction with a rotation of the shaft. The second winding is provided on the rotary member and wound along the circumferential direction.

A motor apparatus according to one embodiment of the disclosure includes a motor, a shaft, an inverter, a magnetic core, a first winding, a rotary member, a second winding, and a rectifying circuit. The motor includes a motor stator and a motor rotor. The motor stator includes a first motor magnetic core and a first motor winding. The motor rotor includes a second motor magnetic core and a second motor winding. The shaft is coupled to the motor rotor. The magnetic core has a ring shape including a through hole through which the shaft extends. The magnetic core includes therein a cavity along a circumferential direction about an axis of rotation of the shaft, and has an opening to the cavity. The opening is provided along the circumferential direction in a surface of the magnetic core different from a surface thereof in contact with the through hole. The first winding is coupled to the inverter, provided in the cavity, and wound along the circumferential direction. The rotary member is coupled to the shaft through the opening, and is rotationally movable, inside the cavity, in the circumferential direction with a rotation of the shaft. The second winding is provided on the rotary member and wound along the circumferential direction. The rectifying circuit is provided in a path coupling the second winding and the second motor winding to each other.

### BRIEF DESCRIPTION OF DRAWINGS

FIG. 1 is a block diagram illustrating a configuration example of a motor apparatus according to one example embodiment of the disclosure.

FIG. 2 is a perspective diagram illustrating a configuration example of an electric power transmission device illustrated in FIG. 1.

FIG. 3 is an explanatory diagram illustrating a configuration example of the electric power transmission device illustrated in FIG. 2.

FIG. 4 is a cross-sectional diagram illustrating a configuration example of the electric power transmission device illustrated in FIG. 2.

FIG. 5 is an explanatory diagram illustrating a configuration example of a stator illustrated in FIG. 4.

FIG. 6 is an explanatory diagram illustrating a configuration example of a rotor illustrated in FIG. 4.

FIG. 7 is an explanatory diagram illustrating an operation example of the electric power transmission device illustrated in FIG. 4.

FIG. 8 is an explanatory diagram illustrating an example of a magnetic flux in the electric power transmission device illustrated in FIG. 4.

FIG. 9 is an explanatory diagram illustrating an example of a magnetic flux in an electric power transmission device according to a reference example.

FIG. 10 is a cross-sectional diagram illustrating a configuration example of an electric power transmission device according to a modification example of the example embodiment illustrated in FIG. 1.

FIG. 11 is a perspective diagram illustrating a configuration example of an electric power transmission device according to another modification example of the example embodiment illustrated in FIG. 1.

FIG. 12 is an explanatory diagram illustrating a configuration example of the electric power transmission device illustrated in FIG. 11.

FIG. 13 is a cross-sectional diagram illustrating a configuration example of the electric power transmission device illustrated in FIG. 11.

FIG. 14 is an explanatory diagram illustrating a configuration example of a stator illustrated in FIG. 13.

FIG. 15 is an explanatory diagram illustrating a configuration example of a rotor illustrated in FIG. 13.

FIG. 16 is a cross-sectional diagram illustrating a configuration example of an electric power transmission device according to another modification example of the example embodiment illustrated in FIG. 1.

FIG. 17 is a block diagram illustrating a configuration example of a motor apparatus according to one example embodiment of the disclosure.

FIG. 18 is a perspective diagram illustrating a configuration example of an electric power transmission device illustrated in FIG. 17.

FIG. 19 is a cross-sectional diagram illustrating a configuration example of the electric power transmission device illustrated in FIG. 17.

FIG. 20 is an explanatory diagram illustrating a configuration example of a stator illustrated in FIG. 19.

FIG. 21 is an explanatory diagram illustrating a configuration example of a rotor illustrated in FIG. 19.

FIG. 22 is an explanatory diagram illustrating an example of a process of manufacturing the electric power transmission device illustrated in FIG. 19.

FIG. 23 is a cross-sectional diagram illustrating a configuration example of an electric power transmission device according to a modification example of the example embodiment illustrated in FIG. 17.

FIG. 24 is a perspective diagram illustrating a configuration example of an electric power transmission device according to another modification example of the example embodiment illustrated in FIG. 17.

FIG. 25 is a cross-sectional diagram illustrating a configuration example of the electric power transmission device illustrated in FIG. 24.

FIG. 26 is an explanatory diagram illustrating a configuration example of a stator illustrated in FIG. 25.

FIG. 27 is an explanatory diagram illustrating a configuration example of a rotor illustrated in FIG. 25.

FIG. 28 is a cross-sectional diagram illustrating a configuration example of an electric power transmission device according to another modification example of the example embodiment illustrated in FIG. 17.

FIG. 29 is a cross-sectional diagram illustrating a configuration example of an electric power transmission device according to another modification example of the example embodiment illustrated in FIG. 17.

FIG. 30 is a cross-sectional diagram illustrating a configuration example of an electric power transmission device according to another modification example of the example embodiment illustrated in FIG. 17.

### DETAILED DESCRIPTION

What is desired of a motor apparatus is to be high in efficiency of a motor, and expectations are placed on further improvement in efficiency of the motor.

It is desirable to provide an electric power transmission device and a motor apparatus that each make it possible to increase efficiency of a motor.

In the following, a description will be given in detail of some example embodiments of the invention with reference to the drawings. The description is given in the following order.
1. First Example Embodiment
2. Second Example Embodiment.

### First Example Embodiment

### Configuration Example

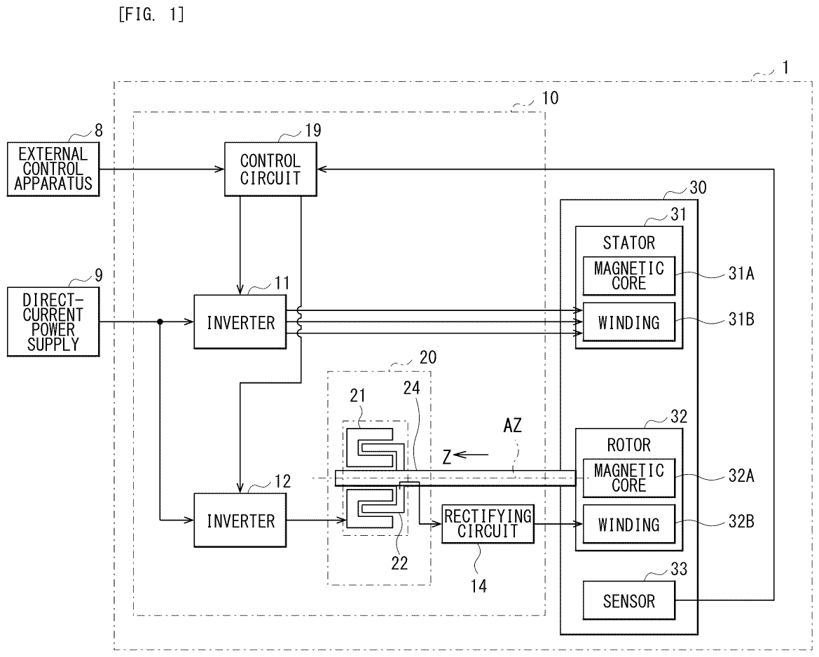

FIG. 1 illustrates a configuration example of a motor apparatus 1 including an electric power transmission device according to a first example embodiment of the disclosure. The motor apparatus 1 is coupled to an external control apparatus 8 and a direct-current power supply 9. The external control apparatus 8 is configured to provide an instruction on a rotation speed to the motor apparatus 1. The direct-current power supply 9 is configured to supply direct-current electric power to the motor apparatus 1. The motor apparatus 1 is configured to generate a driving force, which is mechanical energy, based on an instruction from the external control apparatus 8 and through the use of the direct-current electric power supplied from the direct-current power supply 9. The motor apparatus 1 includes a driver 10 and a motor 30.

The driver 10 is configured to drive the motor 30. The driver 10 includes inverters 11 and 12, an electric power transmission device 20, a rectifying circuit 14, and a control circuit 19.

The inverter 11 is configured to convert direct-current electric power supplied from the direct-current power supply 9 into three-phase (U-phase, V-phase, and W-phase) alternating-current electric power, based on an instruction from the control circuit 19. In addition, the inverter 11 supplies the three-phase alternating-current electric power to a winding 31B of a stator 31 of the motor 30. The winding 31B will be described later.

The inverter 12 is configured to convert direct-current electric power supplied from the direct-current power supply 9 into single-phase alternating-current electric power, based on an instruction from the control circuit 19. In addition, the inverter 12 supplies the alternating-current electric power to a winding 21B of a stator 21 of the electric power transmission device 20. The winding 21B will be described later.

The electric power transmission device 20 is configured to supply alternating-current electric power to the rectifying circuit 14 by contactless transmission. The electric power transmission device 20 includes the stator 21, a rotor 22, and a shaft 24.

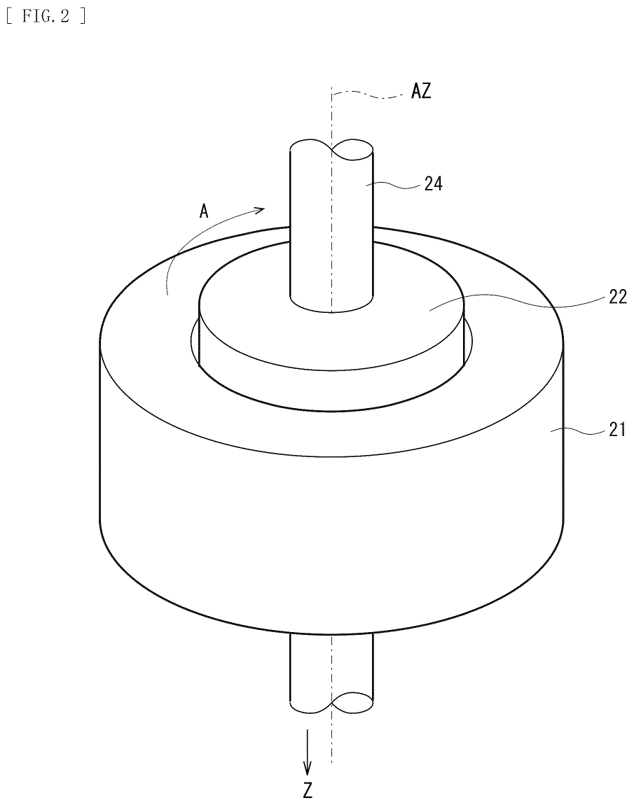

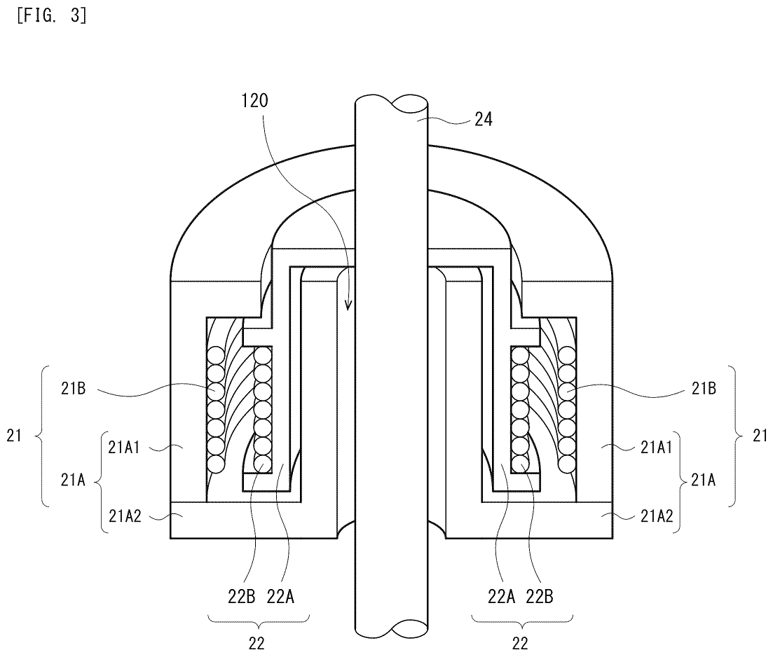

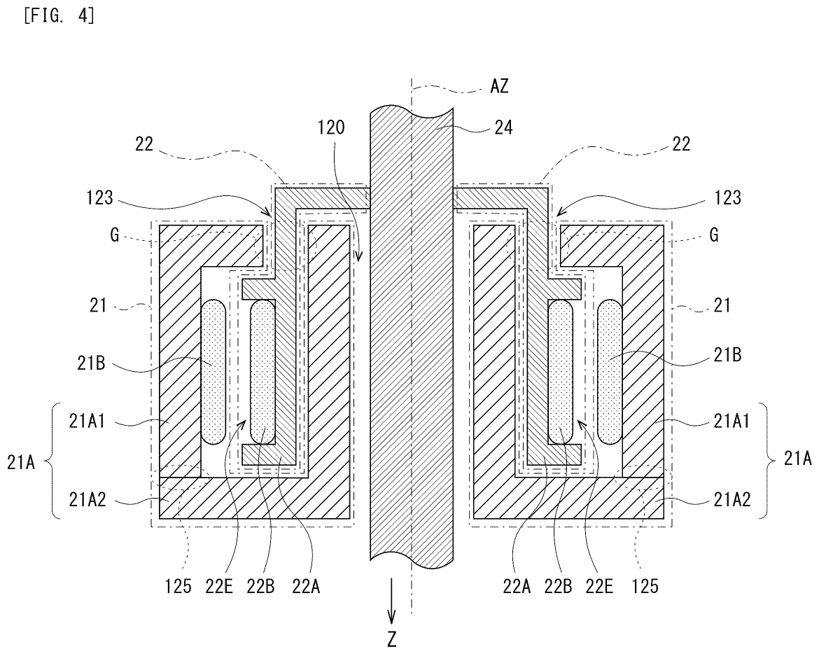

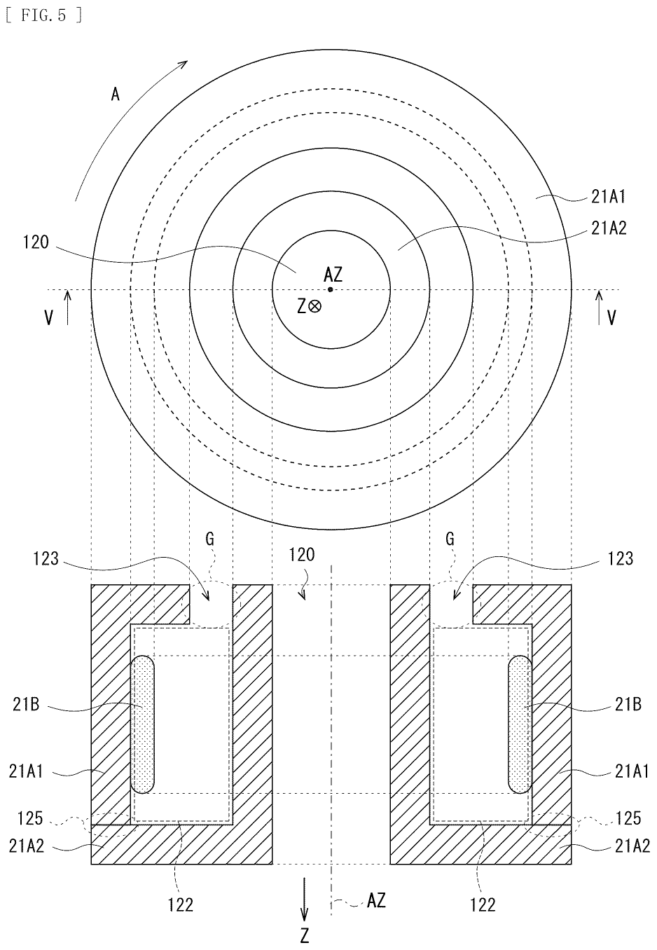

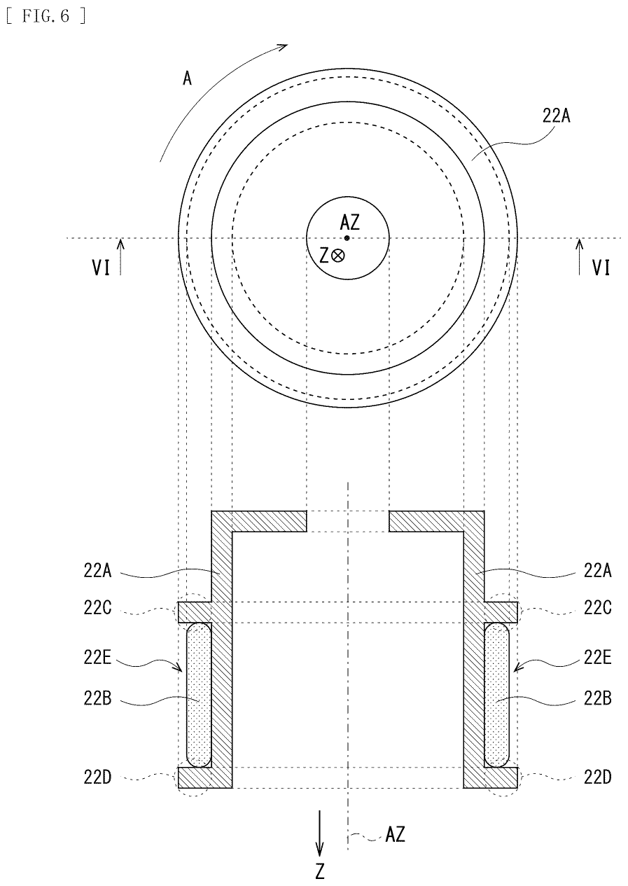

FIGS. 2 and 3 illustrate a configuration example of the electric power transmission device 20. FIG. 4 illustrates an example of a cross-sectional structure of the electric power transmission device 20 in a plane including an axis of rotation AZ. FIG. 5 illustrates a configuration example of the stator 21. FIG. 5 also depicts a cross-sectional structure of the stator 21 in a plane including the axis of rotation AZ as viewed in an arrowed direction V-V. FIG. 6 illustrates a configuration example of the rotor 22. FIG. 6 also depicts a cross-sectional structure of the rotor 22 in a plane including the axis of rotation AZ as viewed in an arrowed direction VI-VI.

The stator 21 is what is called a stator, and is fixed to an unillustrated housing of the motor apparatus 1. The stator 21 includes a magnetic core 21A and the winding 21B, as illustrated in FIGS. 3 to 5.

The magnetic core 21A includes a magnetic material, such as ferrite. The magnetic core 21A is a ring-shaped magnetic member having a through hole 120 through which the shaft 24 extends. The magnetic core 21 A includes a magnetic core 21A1 and a magnetic core 21A2. The magnetic core 21A1 constitutes mainly an outer peripheral part of the magnetic core 21A, and is shaped to bend toward the axis of rotation AZ at an end in a direction opposite to a Z direction. Here, the Z direction is a direction in which the axis of rotation AZ extends, and is from the motor 30 toward the electric power transmission device 20. The magnetic core 21A2 constitutes mainly an inner peripheral part of the magnetic core 21A, and is shaped to bend in a direction away from the axis of rotation AZ at an end in the Z direction. An end in the Z direction of the magnetic core 21A1 is coupled to the magnetic core 21A2 at a coupling part 125. With such a configuration, the magnetic core 21A including the magnetic cores 21A1 and 21A2 is provided with a cavity 122 (FIG. 5) along the circumferential direction A, and is provided with an opening 123 to the cavity 122. The opening 123 is provided in a surface, of the magnetic core 21A, that is in the direction opposite to the Z direction.

The winding 21B is wound multiple times along the circumferential direction A on a surface of a part of the magnetic core 21A1 constituting the outer peripheral part of the magnetic core 21A, the surface facing the magnetic core 21A2. The winding 21B is coupled to the inverter 12 through a hole (not illustrated) provided in the magnetic core 21A1 or the magnetic core 21A2, for example.

The rotor 22 is what is called a rotor, and is configured to rotationally move about the axis of rotation AZ. The rotor 22 is so disposed as to be interposed between the magnetic core 21A1 and the magnetic core 21A2 of the stator 21 in a radial direction (i.e., a horizontal direction in FIG. 3) to the axis of rotation AZ, and is fixed to the shaft 24. As illustrated in FIGS. 3, 4, and 6, the rotor 22 includes a support member 22A and a winding 22B.

The support member 22A has a substantially cylindrical shape, and is shaped to bend toward the shaft 24 at an end in the direction opposite to the Z direction. The support member 22A is coupled to the shaft 24 and rotationally moves in the circumferential direction A about the axis of rotation AZ with a rotation of the shaft 24. The support member 22A includes a resin, for example. A surface of the support member 22A facing the magnetic core 21A1 is provided with a projection 22C, a projection 22D, and a recess 22E. The projection 22C is provided in the surface of the support member 22A facing the magnetic core 21A1 and is positioned in the vicinity of a middle of the support member 22A in the Z direction. The projection 22D is provided in the surface of the support member 22A facing the magnetic core 21A1 and is positioned at an end in the Z direction. The recess 22E is provided in the surface of the support member 22A facing the magnetic core 21A1 and is positioned between the projection 22C and the projection 22D in the Z direction. In a process of manufacturing the electric power transmission device 20, the support member 22A is used as a bobbin on which the winding 22B is to be wound.

The winding 22B is wound multiple times along the recess 22E of the support member 22A. One end and another end of the winding 22B are coupled to the rectifying circuit 14 via the support member 22A and an unillustrated wiring provided on the shaft 24.

In the process of manufacturing the electric power transmission device 20, in this example, the magnetic core 21A1, the rotor 22, and the magnetic core 21A2 are arranged in this order in the Z direction, and the magnetic core 21A1, the rotor 22, and the magnetic core 21A2 are brought close to each other to cause the magnetic core 21A1 and the magnetic core 21A2 to be bonded to each other, for example, at the coupling part 125.

In the electric power transmission device 20, as illustrated in FIGS. 3 and 5, a gap Gis provided between the magnetic core 21A1 and the magnetic core 21A2 in the vicinity of the opening 123. Thus, in the electric power transmission device 20, the magnetic core 21A1 and the magnetic core 21A2 are magnetically coupled to each other in the vicinity of the opening 123. With such a configuration, the electric power transmission device 20 converts alternating-current electric power supplied from the inverter 12 in accordance with a ratio between the number of turns of the winding 21B and the number of turns of the winding 22B, and supplies the converted alternating-current electric power to the rectifying circuit 14. The electric power transmission device 20 is also called a rotary transformer.

The shaft 24 is coupled to a rotor 32 of the motor 30, and is configured to rotate about the axis of rotation AZ, based on a driving force generated by the motor 30.

The rectifying circuit 14 (FIG. 1) is configured to rectify alternating-current electric power supplied from the winding 22B of the rotor 22 and to supply the rectified electric power to a winding 32B of the rotor 32 of the motor 30. The winding 32B will be described later. Although not illustrated, the rectifying circuit 14 is coupled to the shaft 24. More specifically, because the winding 22B and the rotor 32 of the motor 30 are coupled to the shaft 24, the rectifying circuit 14 is also coupled to the shaft 24. Note that although the electric power rectified by the rectifying circuit 14 is directly supplied to the winding 32B in this example, this is non-limiting. Alternatively, for example, the electric power rectified by the rectifying circuit 14 may be supplied to the winding 32B via a stabilizing circuit including a capacitor.

The control circuit 19 is configured to control an operation of each of the inverters 11 and 12, based on an instruction from the external control apparatus 8 and a control signal, supplied from the motor 30, that indicates a rotation speed. Specifically, based on the instruction from the external control apparatus 8 and the control signal indicating the rotation speed of the motor 30, the control circuit 19 controls the operation of the inverter 11 to thereby control the rotation speed of the motor 30. Further, based on the control signal indicating the rotation speed supplied from the motor 30, the control circuit 19 controls the operation of the invertor 12 to thereby control intensity of a magnetic field to be generated by the rotor 32 of the motor 30. Specifically, for example, when the rotation speed of the motor 30 is low, the control circuit 19 intensifies the magnetic field to be generated by the rotor 32 of the motor 30, and when the rotation speed of the motor 30 is high, the control circuit 19 weakens the magnetic field to be generated by the rotor 32 of the motor 30.

The motor 30 is an electrically excited synchronous motor. The motor 30 includes the stator 31, the rotor 32, and a sensor 33.

The stator 31 is what is called a stator, and is fixed to an unillustrated housing of the motor 30. The stator 31 includes a magnetic core 31A and the winding 31B. The winding 31B is to be supplied with the three-phase (U-phase, V-phase, and W-phase) alternating-current electric power generated by the inverter 11.

The rotor 32 is what is called a rotor, and is configured to rotate about the axis of rotation AZ. The rotor 32 includes a magnetic core 32A and the winding 32B. The winding 32B is to be supplied with a signal rectified by the rectifying circuit 14.

The sensor 33 is configured to detect a rotation speed of the rotor 32. In addition, the sensor 33 supplies a control signal indicating the rotation speed of the rotor 32 to the control circuit 19.

With such a configuration, in the motor apparatus 1, the rotation speed of the motor 30 is controlled based on the three-phase (U-phase, V-phase, and W-phase) alternating-current electric power generated by the inverter 11, and the magnetic field to be generated by the rotor 32 of the motor 30 is controlled based on the single-phase alternating-current electric power generated by the inverter 12. In the motor apparatus 1, for example, when the rotation speed of the motor 30 is low, the magnetic field to be generated by the rotor 32 of the motor 30 is intensified, and when the rotation speed of the motor 30 is high, the magnetic field to be generated by the rotor 32 of the motor 30 is weakened. This makes it possible for the motor apparatus 1 to increase efficiency of the motor 30 over a wide rotation speed range.

Here, the shaft 24 corresponds to a specific example of a “shaft” in one embodiment of the disclosure. The axis of rotation AZ corresponds to a specific example of an “axis of rotation” in one embodiment of the disclosure. The magnetic core 21A corresponds to a specific example of a “magnetic core” in one embodiment of the disclosure. The cavity 122 corresponds to a specific example of a “cavity” in one embodiment of the disclosure. The opening 123 corresponds to a specific example of an “opening” in one embodiment of the disclosure. The winding 21B corresponds to a specific example of a “first winding” in one embodiment of the disclosure. The support member 22A corresponds to a specific example of a “rotary member” in one embodiment of the disclosure. The winding 22B corresponds to a specific example of a “second winding” in one embodiment of the disclosure.

The stator 31 corresponds to a specific example of a “motor stator” in one embodiment of the disclosure. The magnetic core 31A corresponds to a specific example of a “first motor magnetic core” in one embodiment of the disclosure. The winding 31B corresponds to a specific example of a “first motor winding” in one embodiment of the disclosure. The rotor 32 corresponds to a specific example of a “motor rotor” in one embodiment of the disclosure. The magnetic core 32A corresponds to a specific example of a “second motor magnetic core” in one embodiment of the disclosure. The winding 32B corresponds to a specific example of a “second motor winding” in one embodiment of the disclosure. The inverter 12 corresponds to a specific example of an “inverter” in one embodiment of the disclosure. The rectifying circuit 14 corresponds to a specific example of a “rectifying circuit” in one embodiment of the disclosure.

### Operation and Workings

Next, a description will be given of operation and workings of the motor apparatus 1 of the present example embodiment.

### Outline of Overall Operation

The control circuit 19 controls the operation of each of the inverters 11 and 12, based on the instruction from the external control apparatus 8 and the control signal, supplied from the motor 30, that indicates the rotation speed. Based on the instruction from the control circuit 19, the inverter 11 converts direct-current electric power supplied from the direct-current power supply 9 into three-phase (U-phase, V-phase, and W-phase) alternating-current electric power, and supplies the three-phase alternating-current electric power to the winding 31B of the stator 31 of the motor 30. Based on the instruction from the control circuit 19, the inverter 12 converts the direct-current electric power supplied from the direct-current power supply 9 into single-phase alternating-current electric power, and supplies the alternating-current electric power to the winding 21B of the stator 21 of the electric power transmission device 20. The electric power transmission device 20 supplies the alternating-current electric power to the rectifying circuit 14 by contactless transmission. The rectifying circuit 14 rectifies the alternating-current electric power supplied from the winding 22B of the rotor 22, and supplies the rectified electric power to the winding 32B of the rotor 32 of the motor 30. The motor 30 generates the driving force, which is mechanical energy, based on the three-phase (U-phase, V-phase, and W-phase) alternating-current electric power supplied from the inverter 11. This causes the shaft 24 to rotate about the axis of rotation AZ. The sensor 33 of the motor 30 supplies the control signal indicating the rotation speed of the motor 30 to the control circuit 19.

### Operation and Workings

Next, a description will be given of operation and workings of the electric power transmission device 20 of the present example embodiment.

The alternating-current electric power is supplied from the inverter 12 to the winding 21B of the stator 21 of the electric power transmission device 20. The rotor 22 rotationally moves in the circumferential direction A illustrated in FIG. 2, for example, about the axis of rotation AZ.

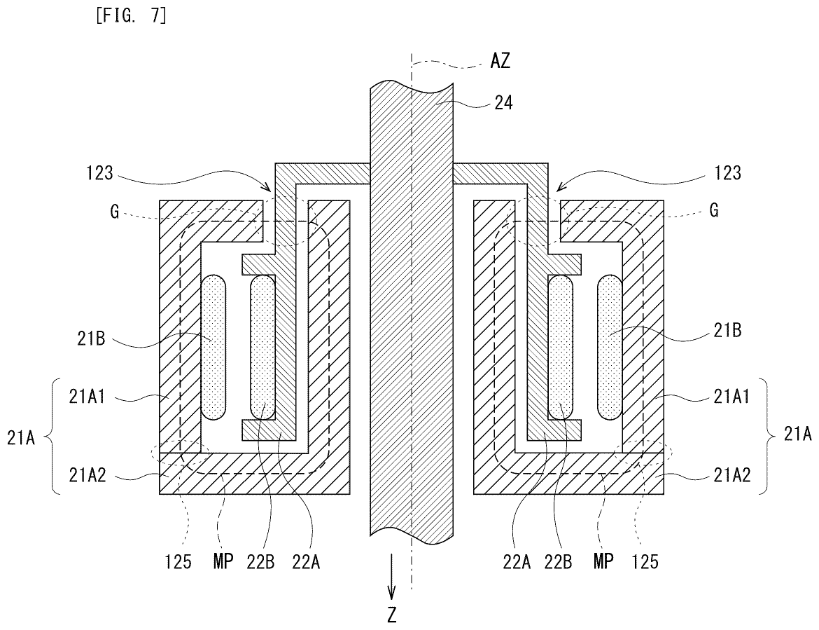

FIG. 7 illustrates a cross-sectional view of the stator 21 and the rotor 22 in the electric power transmission device 20. The winding 21B of the stator 21 generates a magnetic field, based on the alternating-current electric power supplied from the inverter 12. In the vicinity of the opening 123, the magnetic core 21A1 and the magnetic core 21A2 are magnetically coupled to each other.

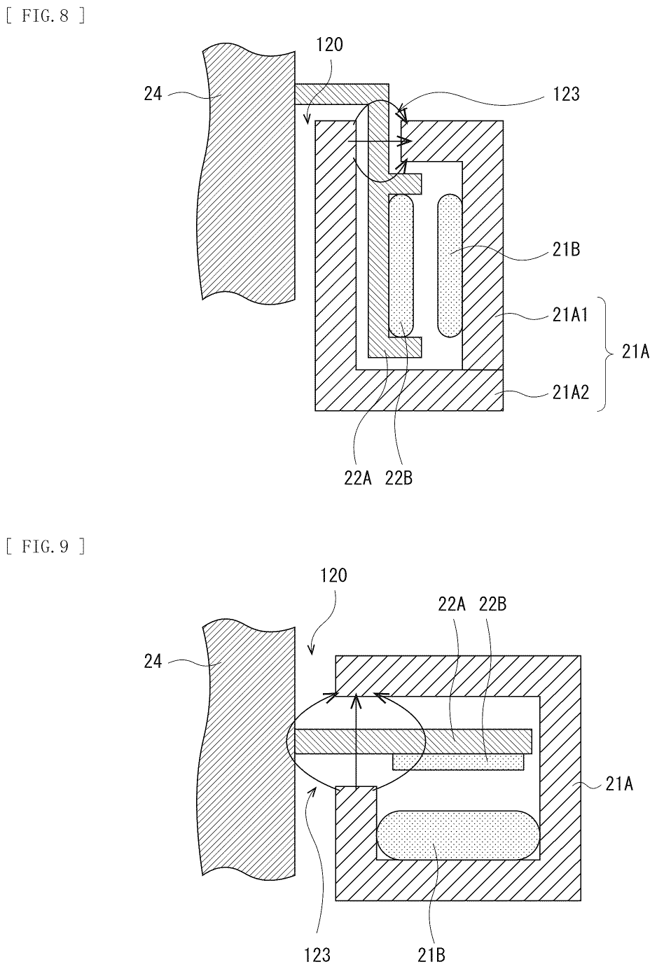

FIG. 8 illustrates an example of a magnetic flux in the opening 123 of the electric power transmission device 20. Note that FIG. 8 omits the illustration of a part of the electric power transmission device 20. A leakage flux occurs in the vicinity of the opening 123. The leakage flux varies in direction depending on a polarity of the alternating-current electric power. In this example, the leakage flux occurring in the vicinity of the opening 123 is in a direction from the magnetic core 21A2 toward the magnetic core 21A1. In this way, in the vicinity of the opening 123, the magnetic core 21A1 and the magnetic core 21A2 are magnetically coupled to each other.

In the electric power transmission device 20, as illustrated in FIG. 7, a magnetic path MP is thus generated that passes through the magnetic core 21A1 and the magnetic core 21A2.

In addition, the winding 22B of the rotor 22 generates alternating-current electric power, based on a magnetic field in the magnetic path MP, and supplies the generated alternating-current electric power to the rectifying circuit 14. In this way, it is possible for the electric power transmission device 20 to supply alternating-current electric power to the rectifying circuit 14 by contactless transmission.

As described above, the electric power transmission device 20 transmits electric power by contactless transmission. This makes it possible to increase reliability as compared with a case of transmitting electric power by contact transmission through the use of, for example, a slip ring and a brush.

The rectifying circuit 14 rectifies the alternating-current electric power supplied from the winding 22B of the rotor 22, and supplies the rectified electric power to the winding 32B of the rotor 32 of the motor 30. A magnetic field is thus generated at the rotor 32 of the motor 30. For example, when the rotation speed of the motor 30 is low, the control circuit 19 intensifies the magnetic field to be generated by the rotor 32 of the motor 30, and when the rotation speed of the motor 30 is high, the control circuit 19 weakens the magnetic field to be generated by the rotor 32 of the motor 30. This makes it possible for the motor apparatus 1 to increase efficiency of the motor 30 over a wide rotation speed range.

As described above, in the electric power transmission device 20, the rotor 22 includes the support member 22A on which the winding 22B is provided. This makes it possible for the rotor 22 to be lightweight as compared with a rotor including a rotor iron core as described in Patent Literature 1, for example. Accordingly, it is possible to reduce a moment of rotation and to reduce an inertial force.

Further, in the electric power transmission device 20, the opening 123 is provided in the surface, of the magnetic core 21A, that is in the direction opposite to the Z direction. This makes it possible to reduce a possibility that a leakage flux enters the shaft 24 in a case where the leakage flux spreads over a larger area at the opening 123.

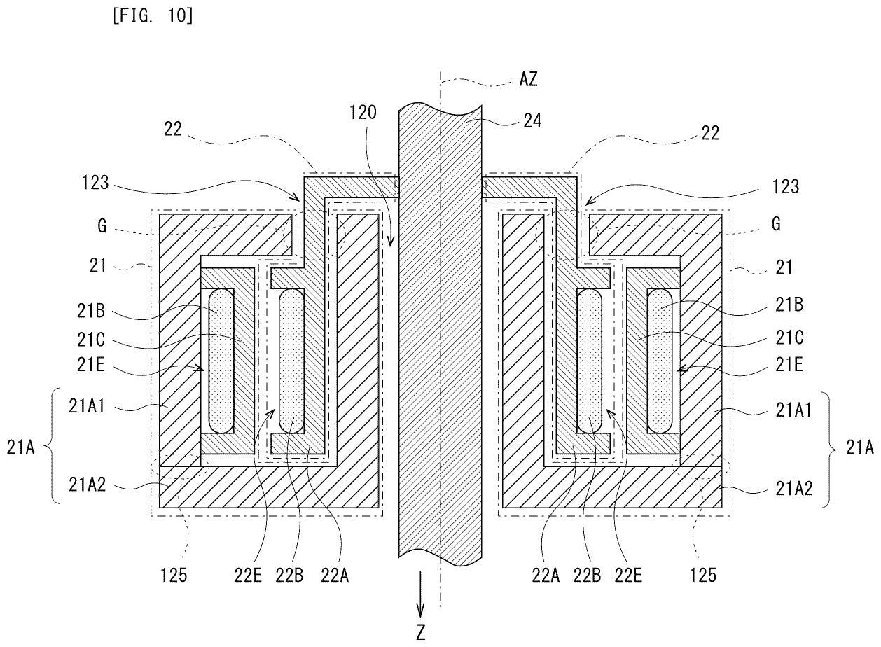

More specifically, for example, if the opening 123 is provided in a surface of the magnetic core 21A1 in contact with the through hole 120 as illustrated in FIG. 9, the leakage flux can spread over a larger area in the radial direction (i.e., the horizontal direction in FIG. 9). If the leakage flux enters the shaft 24, an eddy current would occur in the shaft 24 to result in energy loss.

In contrast, in the electric power transmission device 20, the opening 123 is provided in a surface of the magnetic core 21A different from the surface thereof in contact with the through hole 120. This makes it possible to reduce the possibility that the leakage flux enters the shaft 24 in the case where the leakage flux spreads over a larger area in the vicinity of the opening 123. Accordingly, it is possible for the electric power transmission device 20 to reduce energy loss and to increase efficiency of the motor.

As described above, the electric power transmission device 20 includes the magnetic core 21A, the first winding (the winging 21B), the rotary member (the support member 22A), and the second winding (the winding 22B). The magnetic core 21A has a ring shape including the through hole 120 through which the shaft 24 extends. The magnetic core 21A includes therein the cavity 122 along the circumferential direction A about the axis of rotation AZ of the shaft 24, and has the opening 123 to the cavity 122. The opening 123 is provided along the circumferential direction A in the surface of the magnetic core 21A different from the surface thereof in contact with the through hole 120. The first winding (the winding 21B) is provided in the cavity 122 and wound along the circumferential direction A. The rotary member (the support member 22A) is coupled to the shaft 24 through the opening 123, and is rotationally movable, inside the cavity 122, in the circumferential direction A with the rotation of the shaft 24. The second winding (the winding 22B) is provided on the rotary member (the support member 22A) and wound along the circumferential direction A. This makes it possible to reduce the possibility that the leakage flux in the vicinity of the opening 123 enters the shaft 24. As a result, it is possible for the electric power transmission device 20 to reduce energy loss and to increase efficiency of the motor.

Further, in the electric power transmission device 20, the rotary member (the support member 22A) has the first recess (the recess 22E) provided along the circumferential direction A in a surface of the rotary member (the support member 22A) opposite to a surface thereof that is toward where the axis of rotation AZ is provided. In addition, the second winding (the winding 22B) is wound on the first recess (the recess 22E) of the rotary member (the support member 22A). In a manufacturing process, for example, the rotary member (the support member 22A) is usable as a bobbin to thereby allow the winding 22B to be wound on the rotary member (the support member 22A). This makes it possible to simplify the manufacturing process.

Further, in the electric power transmission device 20, the opening 123 is provided in a surface of the magnetic core 21A intersecting the axis of rotation AZ. This makes it possible to reduce the possibility that the leakage flux in the vicinity of the opening 123 enters the shaft 24. Accordingly, it is possible to increase efficiency of the motor. Further, it is possible to easily couple the support member 22A to the shaft 24, as compared with a case where the opening 123 is provided in, for example, a surface of the magnetic core 21A opposite to the surface thereof in which the through hole 120 is provided.

### Effects

As described above, a magnetic core, a first winding, a rotary member, and a second winding are provided in the present example embodiment. The magnetic core has a ring shape including a through hole through which a shaft extends. The magnetic core includes therein a cavity along a circumferential direction about an axis of rotation of the shaft, and has an opening to the cavity. The opening is provided along the circumferential direction in a surface of the magnetic core different from a surface thereof in contact with the through hole. The first winding is provided in the cavity and wound along the circumferential direction. The rotary member is coupled to the shaft through the opening, and is rotationally movable, inside the cavity, in the circumferential direction with a rotation of the shaft. The second winding is provided on the rotary member and wound along the circumferential direction. This makes it possible to increase efficiency of the motor.

In the present example embodiment, the rotary member has a first recess provided along the circumferential direction in a surface of the rotary member opposite to a surface thereof that is toward where the axis of rotation is provided. The second winding is wound on the first recess of the rotary member. This makes it possible to simplify the manufacturing process.

In the present example embodiment, the opening is provided in a surface of the magnetic core intersecting the axis of rotation. This makes it possible to increase efficiency of the motor and to easily couple the rotary member to the shaft.

### Modification Example 1-1

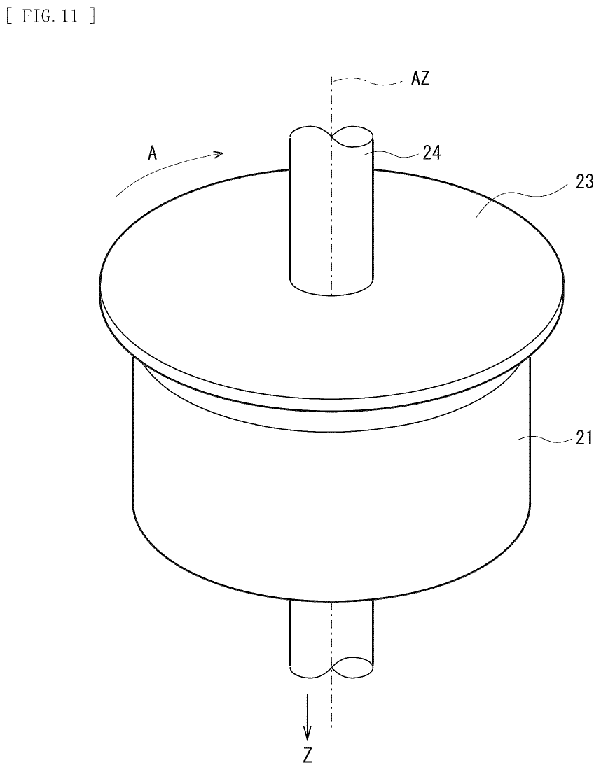

In the foregoing example embodiment, as illustrated in FIGS. 4 and 5, for example, the winding 21B is wound multiple times along the circumferential direction A on the surface facing the magnetic core 21A2, of the part of the magnetic core 21A1 constituting the outer peripheral part of the magnetic core 21A; however, this is non-limiting. Alternatively, as illustrated in FIG. 10, for example, a support member 21C may be provided on the stator 21 and the winding 21B may be wound multiple times on the support member 21C. As with the support member 22A, the support member 21C has a recess 21E provided in a surface facing the magnetic core 21A1, and the winding 21B is wound multiple times along the recess 21E. The support member 21C includes a resin, for example. In the process of manufacturing the electric power transmission device 20, the support member 21C is used as a bobbin on which the winding 21B is to be wound.

### Modification Example 1-2

In the foregoing example embodiment, as illustrated in FIG. 3, the support member 22A itself is coupled to the shaft 24; however, this is non-limiting. Alternatively, the support member 22A may be coupled to the shaft 24 via another member. The present modification example will be described in detail below.

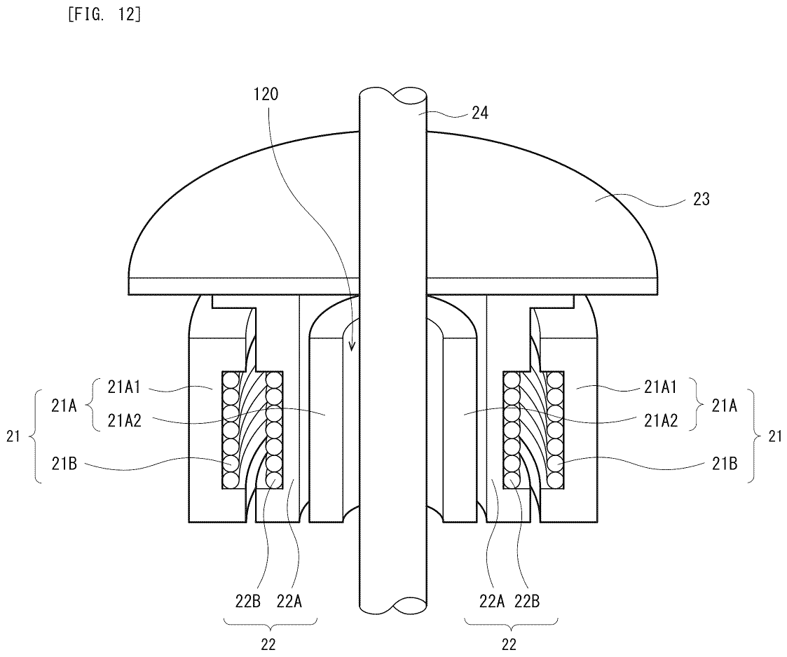

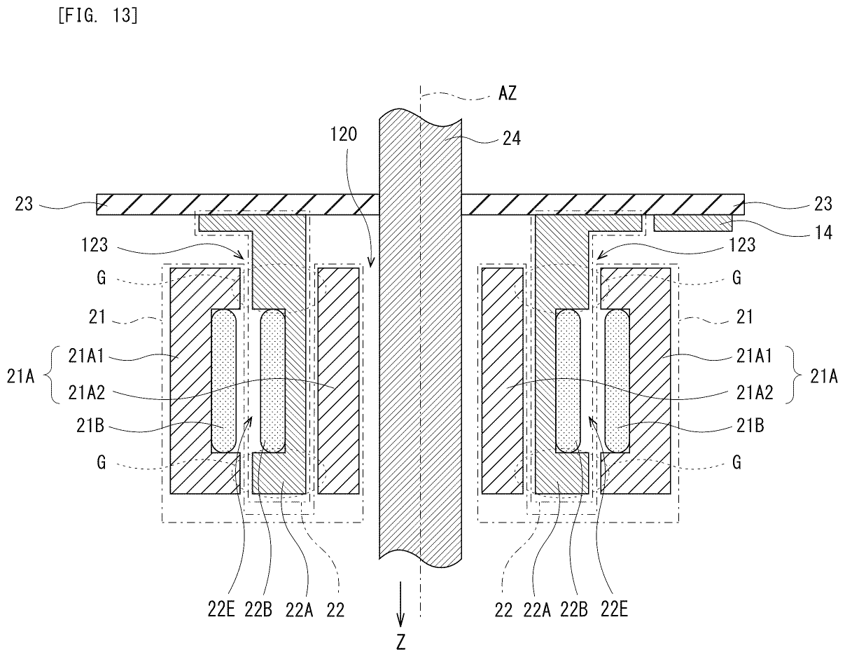

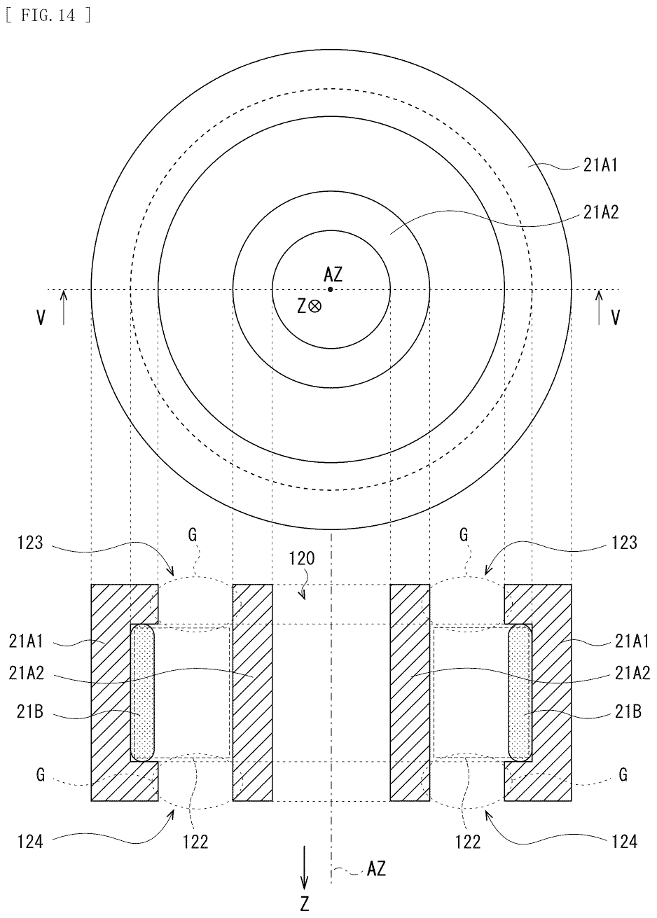

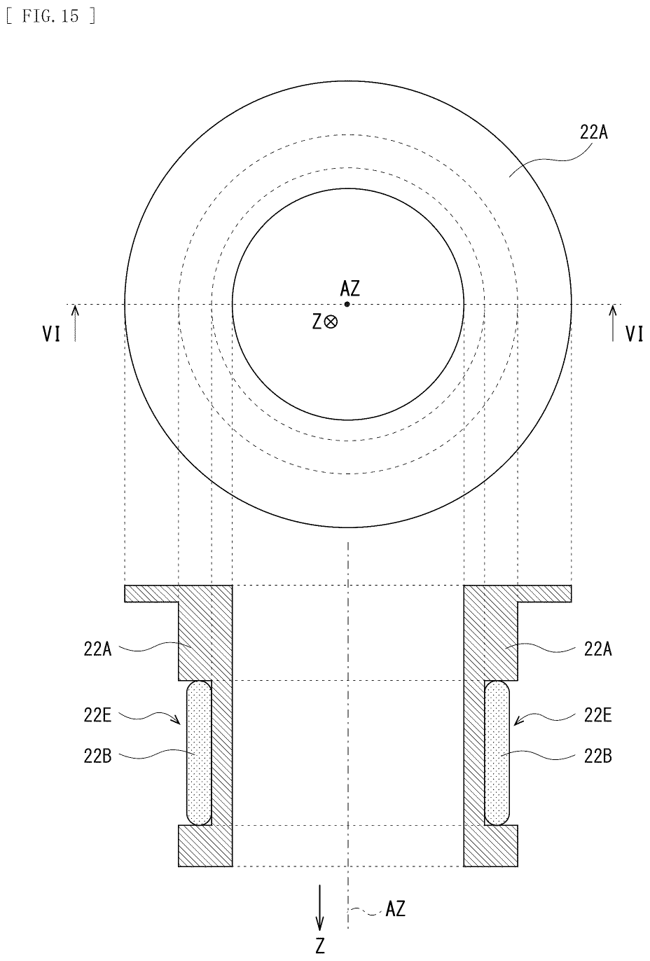

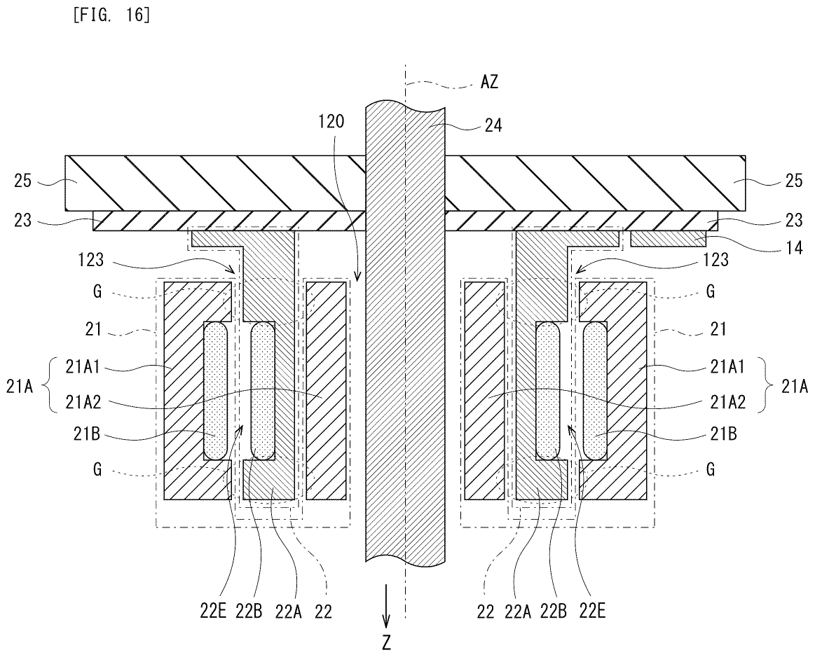

FIGS. 11 and 12 illustrate a configuration example of the electric power transmission device 20 according to the present modification example. FIG. 13 illustrates an example of a cross-sectional structure of the electric power transmission device 20 in a plane including the axis of rotation AZ. FIG. 14 illustrates a configuration example of the stator 21. FIG. 15 illustrates a configuration example of the rotor 22. The electric power transmission device 20 includes the stator 21, the rotor 22, and a coupling member 23.

As illustrated in FIGS. 11 and 12, the stator 21 includes the magnetic core 21A. The magnetic core 21A includes the magnetic core 21A1 and the magnetic core 21A2. The magnetic core 21A1 constitutes mainly the outer peripheral part of the magnetic core 21A. The magnetic core 21A2 constitutes mainly the inner peripheral part of the magnetic core 21A. In this example, the magnetic core 21A1 and the magnetic core 21A2 are not coupled to each other, unlike in the foregoing example embodiment (FIG. 3). In such a case also, the magnetic core 21A including the magnetic cores 21A1 and 21A2 is provided with the cavity 122 (FIG. 12) along the circumferential direction A. Further, the magnetic core 21A is provided with the opening 123 to the cavity 122 and an opening 124 to the cavity 122. The opening 123 is provided in the surface, of the magnetic core 21A, that is in the direction opposite to the Z direction. The opening 124 is provided in a surface, of the magnetic core 21A, that is in the Z direction.

As illustrated in FIGS. 12, 13, and 15, the rotor 22 includes the support member 22A. The support member 22A has a substantially cylindrical shape. The support member 22A is coupled to the shaft 24 via the coupling member 23, and rotationally moves in the circumferential direction A about the axis of rotation AZ with a rotation of the shaft 24. The support member 22A includes a resin, for example. The surface of the support member 22A facing the magnetic core 21A1 is provided with the recess 22E. In the process of manufacturing the electric power transmission device 20, the support member 22A is used as a bobbin on which the winding 22B is to be wound.

The coupling member 23 is a printed circuit board (PCB), for example. The coupling member 23 is coupled to the shaft 24 and to the support member 22A of the rotor 22. In this example, the rectifying circuit 14 is provided on a part of a surface, of the coupling member 23, that is in the Z direction. The rectifying circuit 14 is coupled to the winding 22B of the rotor 22 via the coupling member 23 and the support member 22A of the rotor 22.

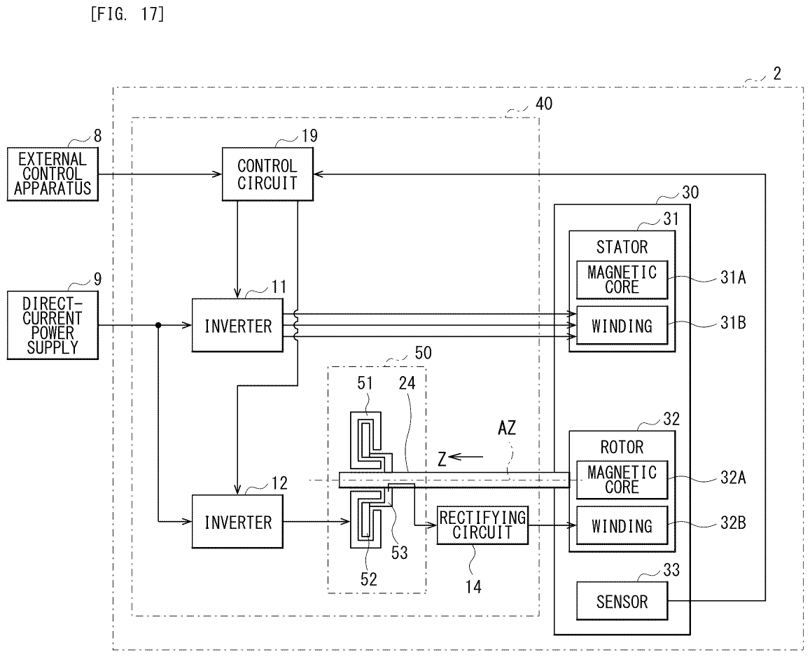

Note that although the electric power transmission device 20 includes the stator 21, the rotor 22, and the coupling member 23 in this example, this is non-limiting. For example, as illustrated in FIG. 16, the electric power transmission device 20 may further include a heat sink 25. In this example, the heat sink 25 is provided on a surface, of the coupling member 23, that is in the direction opposite to the Z direction. The heat sink 25 dissipates heat generated at the winding 22B and/or the rectifying circuit 14.

### Other Modification Examples

Further, two or more of these modification examples may be combined.

### 2. Second Example Embodiment

Next, a description will be given of a motor apparatus 2 according to a second example embodiment. In the present example embodiment, the electric power transmission device has a configuration different from that in the foregoing first example embodiment. Note that components substantially the same as those in the motor apparatus 1 according to the foregoing first example embodiment are denoted with the same reference signs and descriptions thereof are omitted where appropriate.

FIG. 17 illustrates a configuration example of the motor apparatus 2 according to the second example embodiment. The motor apparatus 2 includes a driver 40 and the motor 30. The driver 40 includes an electric power transmission device 50. The electric power transmission device 50 includes a stator 51, a rotor 52, a coupling member 53, and the shaft 24.

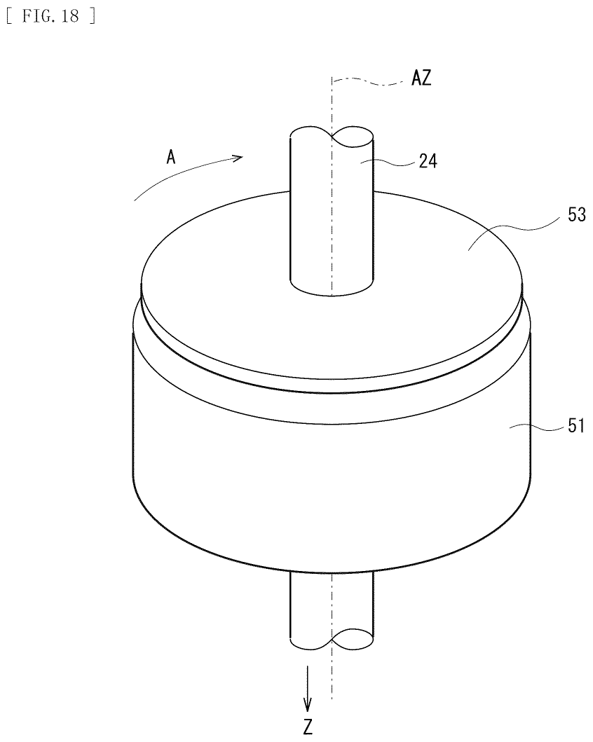

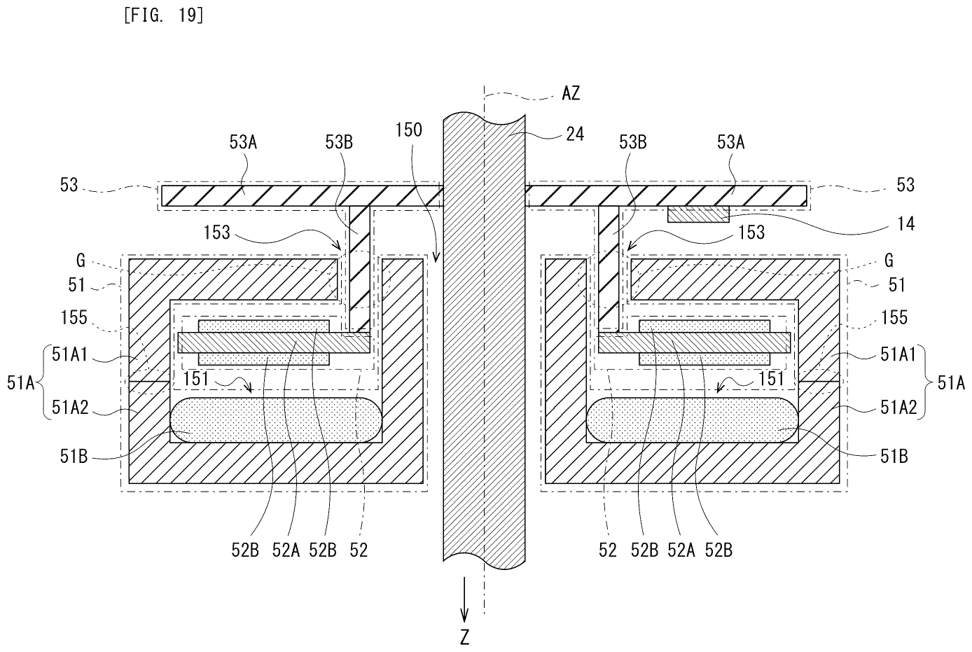

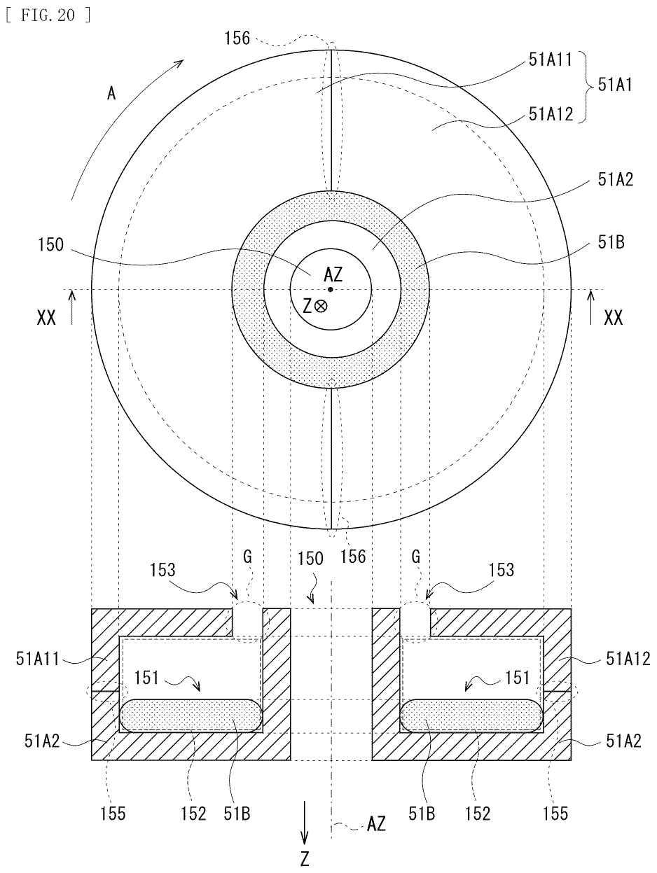

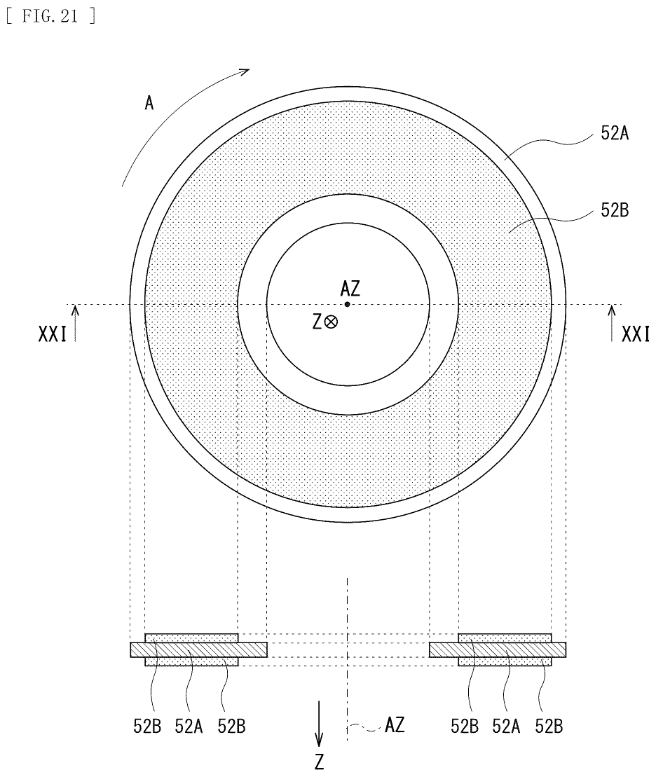

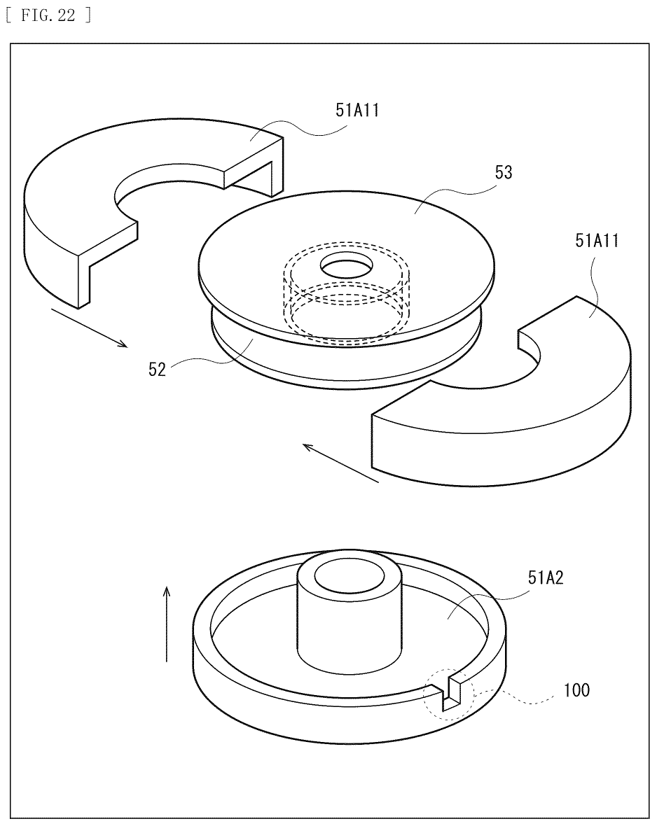

FIG. 18 illustrates a configuration example of the electric power transmission device 50. FIG. 19 illustrates an example of a cross-sectional structure of the electric power transmission device 50 in a plane including the axis of rotation AZ. FIG. 20 illustrates a configuration example of the stator 51. FIG. 21 illustrates a configuration example of the rotor 52.

As illustrated in FIGS. 19 and 20, the stator 51 includes a magnetic core 51A and a winding 51B.

The magnetic core 51A is a ring-shaped magnetic member having a through hole 150 through which the shaft 24 extends. The magnetic core 51A includes a magnetic core 51A1 and a magnetic core 51A2. The magnetic core 51A1 constitutes a surface of the magnetic core 51A in the direction opposite to the Z direction, and is shaped to bend in the Z direction at a part thereof located on an outer side in the radial direction (i.e., the horizontal direction in FIG. 19). As illustrated in FIG. 20, the magnetic core 51A1 includes a magnetic core 51A11 and a magnetic core 51A12. The magnetic core 51A11 and the magnetic core 51A12 are each shaped as half of a ring shape in a plane intersecting the Z direction, and are bonded to each other at a coupling part 156 (FIG. 20). The magnetic core 51A2 constitutes a surface of the magnetic core 51A in the Z direction, and is shaped to bend in the direction opposite to the Z direction at both a part thereof located on the outer side in the radial direction (i.e., the horizontal direction in FIG. 19) and a part thereof located on an inner side in the radial direction. The magnetic core 51A2 has a recess 151 in a part sandwiched by the part located on the outer side in the radial direction (i.e., the horizontal direction in FIG. 19) and the part located on the inner side in the radial direction. The magnetic core 51A1 and the magnetic core 51A2 are bonded to each other at a coupling part 155 located in an outer peripheral part of the magnetic core 51A. With such a configuration, the magnetic core 51A including the magnetic cores 51A1 and 51A2 is provided with a cavity 152 (FIG. 20) along the circumferential direction A, and is provided with an opening 153 to the cavity 152. The opening 153 is provided in the surface, of the magnetic core 51A, that is in the direction opposite to the Z direction.

The winding 51B is wound multiple times along the recess 151 of the magnetic core 51A2. The winding 51B is coupled to the inverter 12 through a hole (a notch 100 to be described later) provided in the magnetic core 51A2, for example.

The rotor 52 is so disposed as to be interposed between the magnetic core 51A1 and the magnetic core 51A2 of the stator 51 in the Z direction, and is fixed to the shaft 24 via the coupling member 53. As illustrated in FIGS. 19 and 21, the rotor 52 includes a substrate 52A and a winding 52B.

The substrate 52A is a printed circuit board, for example. The substrate 52A is coupled to the shaft 24 via the coupling member 53, and rotationally moves in the circumferential direction A about the axis of rotation AZ with the rotation of the shaft 24.

The winding 52B includes a patterned wiring provided on the substrate 52A, and is wound multiple times along the circumferential direction A (FIG. 21) about the axis of rotation AZ. The winding 52B includes a metal material, such as copper. In this example, the winding 52B is provided on both surfaces of the substrate 52A. Note that this is non-limiting, and the winding 52B may be provided on one of both surfaces of the substrate 52A. Further, when the substrate 52A is a multilayer substrate, the winding 52B may include a patterned wiring within the substrate 52A. One end and another end of the winding 52B are coupled to the rectifying circuit 14 via the substrate 52A and an unillustrated wiring provided on the shaft 24.

In a process of manufacturing the electric power transmission device 50, first, as illustrated in FIG. 22, the rotor 52 and the coupling member 53 are coupled to each other. Thereafter, the magnetic core 51A11 and the magnetic core 51A12 are brought close to each other to sandwich the rotor 52 and the coupling member 53 from both sides of the rotor 52 and the coupling member 53. The magnetic core 51A11 and the magnetic core 51A12 are bonded to each other into the magnetic core 51A1. Thereafter, the magnetic core 51A1 is bonded to the magnetic core 51A2 on which the winding 51B is provided. In FIG. 22, the magnetic core 51A2 has the notch 100. The winding 51B is coupled to the inverter 12 through the notch 100.

In the electric power transmission device 50, as illustrated in FIGS. 19 and 20, a gap G is provided between the magnetic core 51A1 and the magnetic core 51A2 in the vicinity of the opening 153. Thus, in the electric power transmission device 50, the magnetic core 51A1 and the magnetic core 51A2 are magnetically coupled to each other in the vicinity of the opening 153. With such a configuration, the electric power transmission device 50 converts alternating-current electric power supplied from the inverter 12 in accordance with a ratio between the number of turns of the winding 51B and the number of turns of the winding 52B, and supplies the converted alternating-current electric power to the rectifying circuit 14.

The coupling member 53 is configured to couple the rotor 52 to the shaft 24. The coupling member 53 includes a coupling member 53A and a coupling member 53B. The coupling member 53A is a printed circuit board, for example. The coupling member 53A is coupled to the shaft 24 and to the coupling member 53B. In this example, the rectifying circuit 14 is provided on a part of a surface, of the coupling member 53A, that is in the Z direction. The rectifying circuit 14 is coupled to the winding 52B of the rotor 52 via the coupling member 53A, the coupling member 53B, and the substrate 52A of the rotor 52. The coupling member 53B has a cylindrical shape. The coupling member 53B is coupled to the surface, of the coupling member 53A, that is in the Z direction, and coupled to the substrate 52A of the rotor 52 through the opening 153.

Here, the magnetic core 51A corresponds to a specific example of the “magnetic core” in one embodiment of the disclosure. The cavity 152 corresponds to a specific example of the “cavity” in one embodiment of the disclosure. The opening 153 corresponds to a specific example of the “opening” in one embodiment of the disclosure. The winding 51B corresponds to a specific example of the “first winding” in one embodiment of the disclosure. The substrate 52A corresponds to a specific example of the “rotary member” in one embodiment of the disclosure. The winding 52B corresponds to a specific example of the “second winding” in one embodiment of the disclosure.

In the electric power transmission device 50, the opening 153 is provided in the surface, of the magnetic core 51A, that is in the direction opposite to the Z direction. This makes it possible to reduce a possibility that a leakage flux enters the shaft 24 in a case where the leakage flux spreads over a larger area at the opening 153. Accordingly, it is possible for the electric power transmission device 50 to reduce energy loss and to increase efficiency of the motor.

As described above, the electric power transmission device 50 includes the magnetic core 51A, the first winding (the winging 51B), the rotary member (the substrate 52A), and the second winding (the winding 52B). The magnetic core 51A has a ring shape including the through hole 150 through which the shaft 24 extends. The magnetic core 51A includes therein the cavity 152 along the circumferential direction A about the axis of rotation AZ of the shaft 24, and has the opening 153 to the cavity 152. The opening 153 is provided along the circumferential direction A in a surface of the magnetic core 51A different from a surface thereof in contact with the through hole 150. The first winding (the winding 51B) is provided in the cavity 152 and wound along the circumferential direction A. The rotary member (the substrate 52A) is coupled to the shaft 24 through the opening 153, and is rotationally movable, inside the cavity 152, in the circumferential direction A with the rotation of the shaft 24. The second winding (the winding 52B) is provided on the rotary member (the substrate 52A) and wound along the circumferential direction A. This makes it possible to reduce a possibility that a leakage flux in the vicinity of the opening 153 enters the shaft 24. As a result, it is possible for the electric power transmission device 50 to reduce energy loss and to increase efficiency of the motor.

Further, in the electric power transmission device 50, the opening 153 is provided in a surface of the magnetic core 51A intersecting the axis of rotation AZ. This makes it possible to reduce the possibility that the leakage flux in the vicinity of the opening 153 enters the shaft 24. Accordingly, it is possible to increase efficiency of the motor. Further, it is possible to easily couple the rotary member (the substrate 52A) to the shaft 24, as compared with a case where the opening 153 is provided in, for example, a surface of the magnetic core 51A opposite to a surface thereof in which the through hole 150 is provided.

### Effects

As described above, a magnetic core, a first winding, a rotary member, and a second winding are provided in the present example embodiment. The magnetic core has a ring shape including a through hole through which a shaft extends. The magnetic core includes therein a cavity along a circumferential direction about an axis of rotation of the shaft, and has an opening to the cavity. The opening is provided along the circumferential direction in a surface of the magnetic core different from a surface thereof in contact with the through hole. The first winding is provided in the cavity and wound along the circumferential direction. The rotary member is coupled to the shaft through the opening, and is rotationally movable, inside the cavity, in the circumferential direction with a rotation of the shaft. The second winding is provided on the substrate and wound along the circumferential direction. This makes it possible to increase efficiency of the motor.

In the present example embodiment, the opening is provided in a surface of the magnetic core intersecting the axis of rotation. This makes it possible to increase efficiency of the motor and to easily couple the rotary member to the shaft.

### Modification Example 2-1

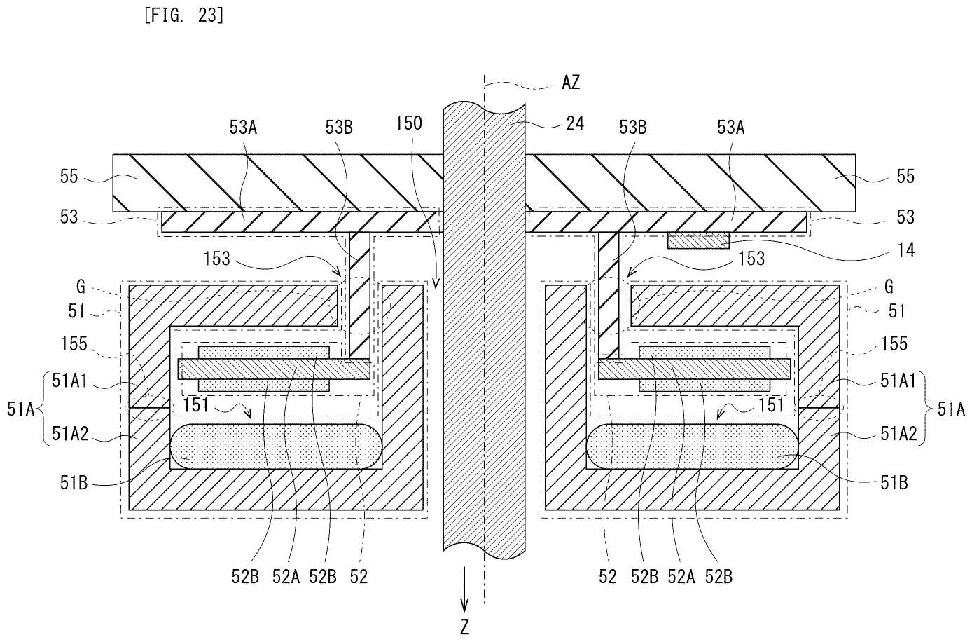

In the foregoing example embodiment, the electric power transmission device 50 includes the stator 51, the rotor 52, and the coupling member 53; however, this is non-limiting. For example, as illustrated in FIG. 23, the electric power transmission device 50 may further include a heat sink 55. In this example, the heat sink 55 is provided on a surface, of the coupling member 53, that is in the direction opposite to the Z direction. The heat sink 55 dissipates heat generated at the winding 52B and/or the rectifying circuit 14.

### Modification Example 2-2

In the foregoing example embodiment, as illustrated in FIG. 23, the opening 153 is provided in the surface, of the magnetic core 51A, that is in the direction opposite to the Z direction; however, this is non-limiting. Alternatively, for example, an opening may be provided in a surface, of the magnetic core 51A, located on the outer side in the radial direction to the axis of rotation AZ. The present modification example will be described in detail below.

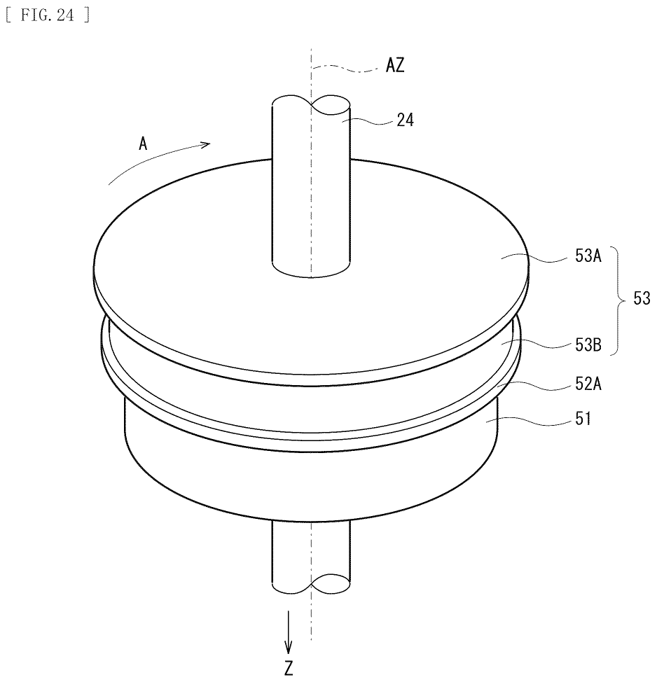

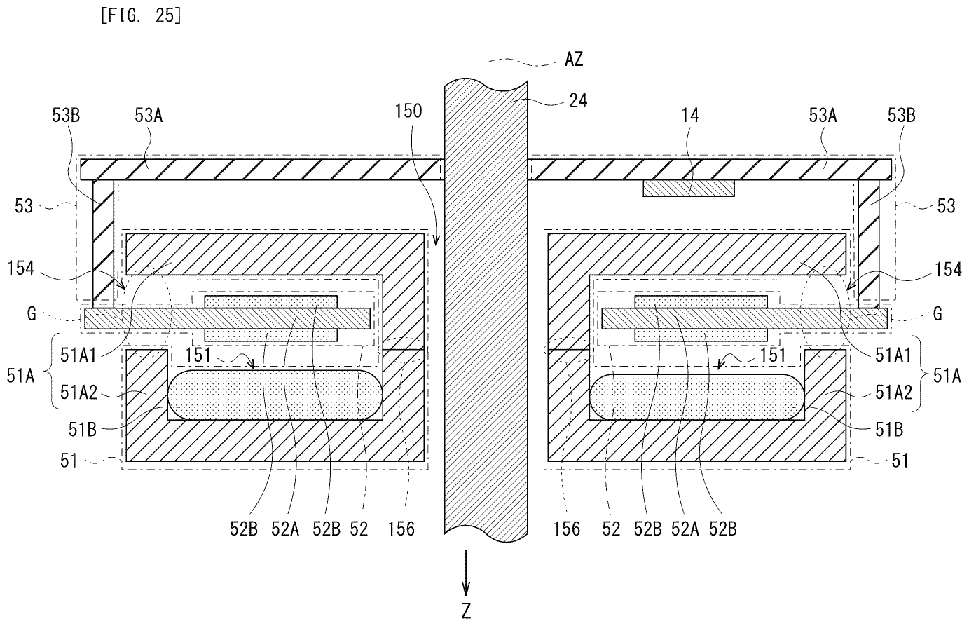

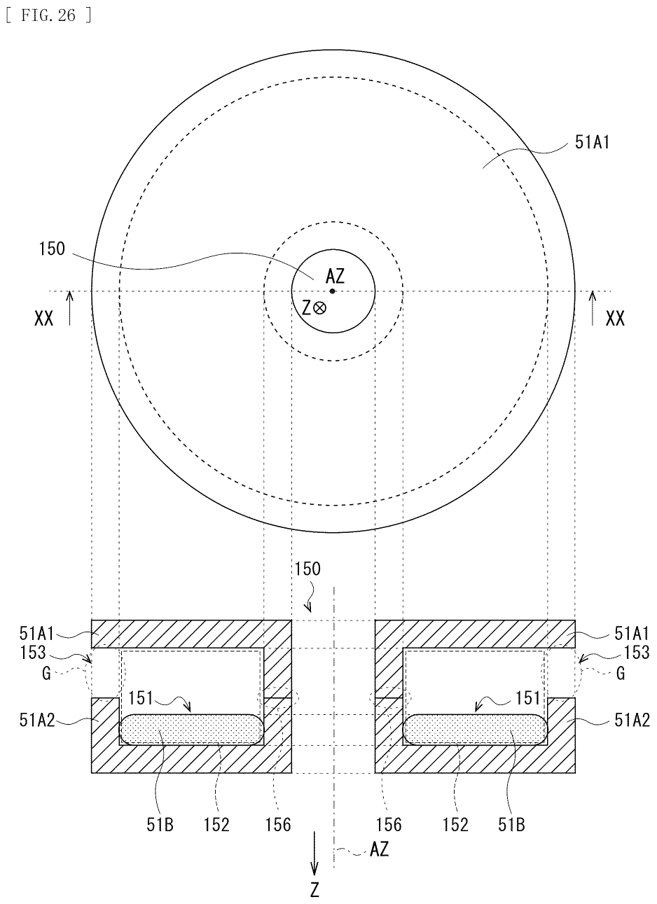

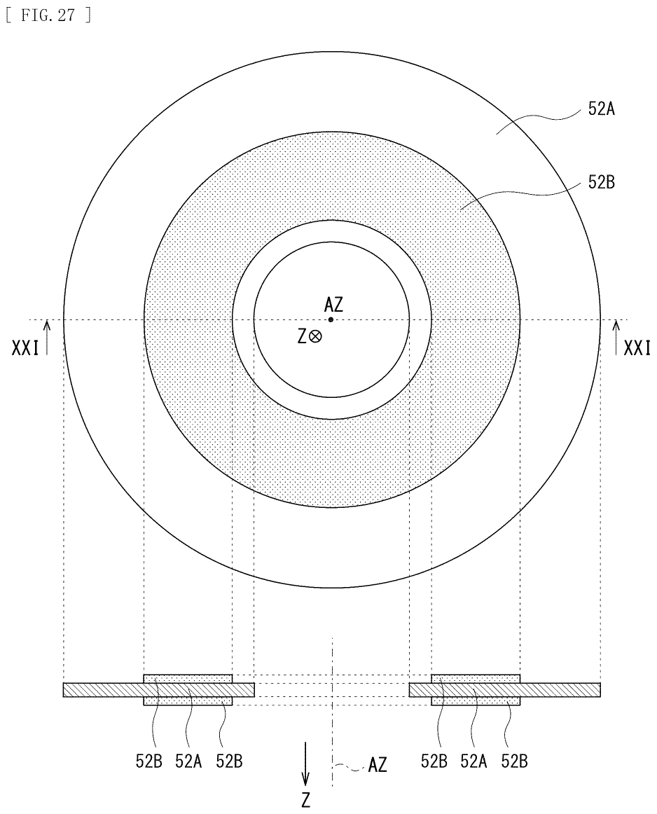

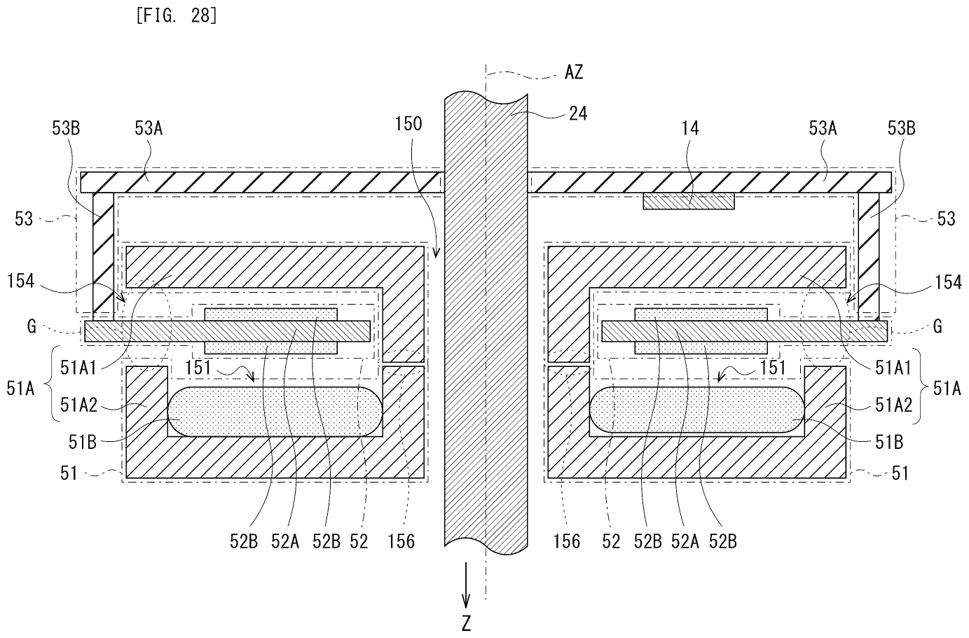

FIG. 24 illustrates a configuration example of the electric power transmission device 50 according to the present modification example. FIG. 25 illustrates an example of a cross-sectional structure of the electric power transmission device 50 in a plane including the axis of rotation AZ. FIG. 26 illustrates a configuration example of the stator 51. FIG. 27 illustrates a configuration example of the rotor 52.

As illustrated in FIGS. 25 and 26, the stator 51 includes the magnetic core 51A. The magnetic core 51A includes the magnetic core 51A1 and the magnetic core 51A2. The magnetic core 51A1 constitutes the surface of the magnetic core 51A in the direction opposite to the Z direction, and is shaped to bend in the Z direction at a part thereof located on the inner side in the radial direction (i.e., the horizontal direction in FIG. 25). The magnetic core 51A2 constitutes the surface of the magnetic core 51A in the Z direction, and is shaped to bend in the direction opposite to the Z direction at both the part thereof located on the outer side in the radial direction (i.e., the horizontal direction in FIG. 25) and the part thereof located on the inner side in the radial direction. The magnetic core 51A1 and the magnetic core 51A2 are bonded to each other at the coupling part 156 located in an inner peripheral part of the magnetic core 51A. With such a configuration, the magnetic core 51A including the magnetic cores 51A1 and 51A2 is provided with an opening 154 to the cavity 152. The opening 154 is provided in the surface, of the magnetic core 51A, located on the outer side in the radial direction (i.e., the horizontal direction in FIG. 25). Here, the opening 154 corresponds to a specific example of the “opening” in one embodiment of the disclosure.

As illustrated in FIGS. 25 and 27, the rotor 52 includes the substrate 52A. As illustrated in FIG. 25, the substrate 52A is provided to extend outward relative to the opening 154 in the radial direction (i.e., the horizontal direction in FIG. 25).

In the electric power transmission device 50, as illustrated in FIGS. 25 and 26, a gap G is provided between the magnetic core 51A1 and the magnetic core 51A2 in the vicinity of the opening 154. Thus, in the electric power transmission device 50, the magnetic core 51A1 and the magnetic core 51A2 are magnetically coupled to each other in the vicinity of the opening 154. With such a configuration, the electric power transmission device 50 converts alternating-current electric power supplied from the inverter 12 in accordance with the ratio between the number of turns of the winding 51B and the number of turns of the winding 52B, and supplies the converted alternating-current electric power to the rectifying circuit 14.

The coupling member 53 includes the coupling member 53A and the coupling member 53B. The coupling member 53A is a printed circuit board, for example. The coupling member 53A is coupled to the shaft 24 and to the coupling member 53B. The coupling member 53B has a cylindrical shape, and is coupled to the surface, of the coupling member 53A, that is in the Z direction, and coupled to the substrate 52A of the rotor 52 on the outer side in the radial direction (i.e., the horizontal direction in FIG. 25) relative to the magnetic core 51A.

Note than when bonding the magnetic core 51A1 and the magnetic core 51A2 to each other, a gap can develop between the magnetic core 51A1 and the magnetic core 51A2 at the coupling part 156, as illustrated in FIG. 28. Even in such a case, the gap is small in width and therefore wide spreading of the leakage flux is avoidable. Accordingly, there is a low possibility that the leakage flux enters the shaft 24.

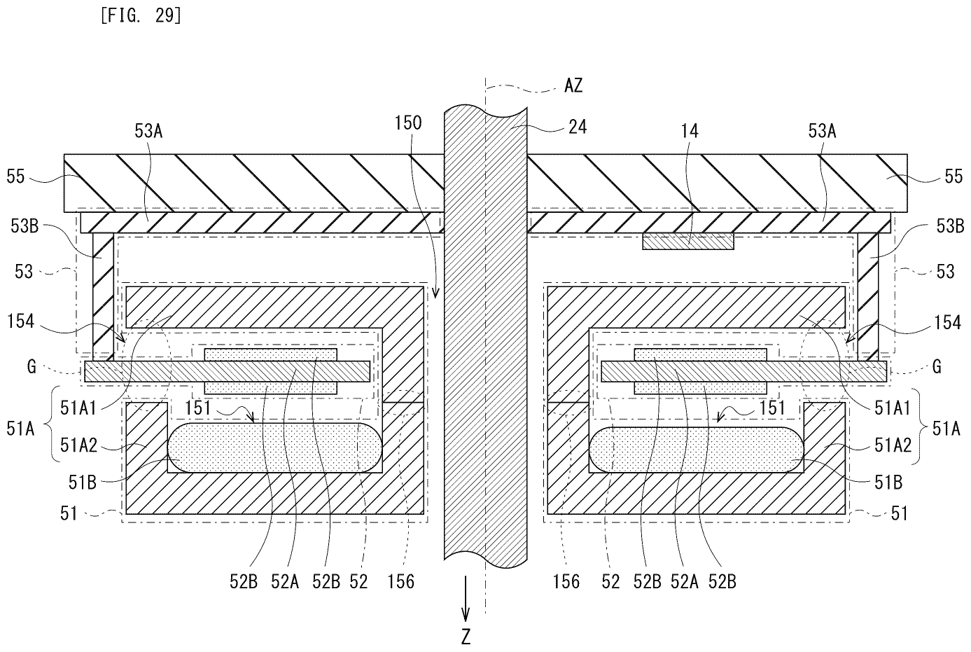

Further, although the electric power transmission device 50 includes the stator 51, the rotor 52, and the coupling member 53, this is non-limiting. For example, as illustrated in FIG. 29, the electric power transmission device 50 may further include a heat sink 55. In this example, the heat sink 55 is provided on the surface, of the coupling member 53, that is in the direction opposite to the Z direction. The heat sink 55 dissipates heat generated at the winding 52B and/or the rectifying circuit 14.

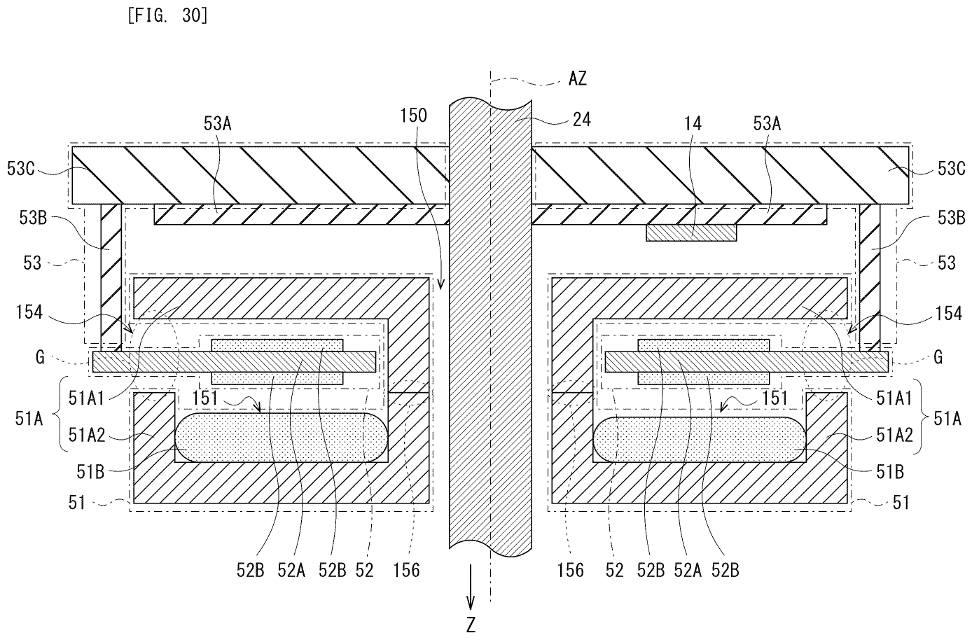

Further, in the electric power transmission device 50, the coupling member 53A that is a printed circuit board is used as the coupling member 53; however, this is non-limiting. Alternatively, for example, a heat sink 53C may be used as the coupling member 53, as illustrated in FIG. 30. The heat sink 53C is coupled to the shaft 24 and to the coupling member 53B.

### Other Modification Examples

Further, two or more of these modification examples may be combined.

The disclosure has been described hereinabove with reference to the example embodiments and the modification examples. However, the disclosure is not limited thereto, and may be modified in a variety of ways.

For example, the shapes of the stators 21 and 51 and the rotors 22 and 52 illustrated in the foregoing example embodiments and the modification examples are mere examples, and their shapes are not limited to the disclosed ones.

The effects described in the present specification are mere examples, and effects of the disclosure are not limited to those described in the present specification. Accordingly, the disclosure may achieve any other effect.

Further, the disclosure may encompass the following embodiments.

1

An electric power transmission device including:
a magnetic core having a ring shape including a through hole through which a shaft extends, the magnetic core including therein a cavity along a circumferential direction about an axis of rotation of the shaft, and having an opening to the cavity, the opening being provided along the circumferential direction in a surface of the magnetic core different from a surface thereof in contact with the through hole;
a first winding provided in the cavity and wound along the circumferential direction;
a rotary member coupled to the shaft through the opening, the rotary member being rotationally movable, inside the cavity, in the circumferential direction with a rotation of the shaft; and
a second winding provided on the rotary member and wound along the circumferential direction.
   2

The electric power transmission device according to (1), in which
the rotary member has a first recess provided along the circumferential direction in a surface of the rotary member opposite to a surface thereof that is toward where the axis of rotation is provided, and
the second winding is wound on the first recess of the rotary member.
   3

The electric power transmission device according to (1) or (2), further including
a support member positioned inside the cavity, the support member having a second recess provided along the circumferential direction in a surface of the support member opposite to a surface thereof that is toward where the axis of rotation is provided, in which
the first winding is wound on the second recess of the support member.
   4

The electric power transmission device according to any one of (1) to (3), further including
a coupling member coupled to the shaft at a position along an axial direction of the axis of rotation different from a position at which the magnetic core is provided, in which
the rotary member is coupled to the shaft via the coupling member.
   5

The electric power transmission device according to (4), further including
a rectifying circuit coupled to the second winding, in which
the coupling member includes a substrate on which the rectifying circuit is provided.
   6

The electric power transmission device according to (4), in which the coupling member includes a heat sink.

7

The electric power transmission device according to any one of (1) to (6), in which the opening is provided in a surface of the magnetic core intersecting the axis of rotation.

8

The electric power transmission device according to any one of (1) to (7), in which the opening is provided in a surface of the magnetic core opposite to, in a radial direction to the axis of rotation, a surface thereof in which the through hole is provided.

9

A motor apparatus including:
a motor including a motor stator and a motor rotor, the motor stator including a first motor magnetic core and a first motor winding, the motor rotor including a second motor magnetic core and a second motor winding;
a shaft coupled to the motor rotor;
an inverter;
a magnetic core having a ring shape including a through hole through which the shaft extends, the magnetic core including therein a cavity along a circumferential direction about an axis of rotation of the shaft, and having an opening to the cavity, the opening being provided along the circumferential direction in a surface of the magnetic core different from a surface thereof in contact with the through hole;
a first winding coupled to the inverter, provided in the cavity, and wound along the circumferential direction;
a rotary member coupled to the shaft through the opening, the rotary member being rotationally movable, inside the cavity, in the circumferential direction with a rotation of the shaft;
a second winding provided on the rotary member and wound along the circumferential direction; and
a rectifying circuit provided in a path coupling the second winding and the second motor winding to each other.

The electric power transmission device and the motor apparatus according to at least one embodiment of the disclosure each make it possible to increase efficiency of the motor.

1. An electric power transmission device comprising:
a magnetic core having a ring shape including a through hole through which a shaft extends, the magnetic core including therein a cavity along a circumferential direction about an axis of rotation of the shaft, and having an opening to the cavity, the opening being provided along the circumferential direction in a surface of the magnetic core different from a surface thereof in contact with the through hole;
a first winding provided in the cavity and wound along the circumferential direction;
a rotary member coupled to the shaft through the opening, the rotary member being rotationally movable, inside the cavity, in the circumferential direction with a rotation of the shaft; and
a second winding provided on the rotary member and wound along the circumferential direction.

2. The electric power transmission device according to claim 1, wherein
the rotary member has a first recess provided along the circumferential direction in a surface of the rotary member opposite to a surface thereof that is toward where the axis of rotation is provided, and
the second winding is wound on the first recess of the rotary member.

3. The electric power transmission device according to claim 1, further comprising
a support member positioned inside the cavity, the support member having a second recess provided along the circumferential direction in a surface of the support member opposite to a surface thereof that is toward where the axis of rotation is provided, wherein
the first winding is wound on the second recess of the support member.

4. The electric power transmission device according to claim 1, further comprising
a coupling member coupled to the shaft at a position along an axial direction of the axis of rotation different from a position at which the magnetic core is provided, wherein
the rotary member is coupled to the shaft via the coupling member.

5. The electric power transmission device according to claim 4, further comprising
a rectifying circuit coupled to the second winding, wherein
the coupling member includes a substrate on which the rectifying circuit is provided.

6. The electric power transmission device according to claim 4, wherein the coupling member includes a heat sink.

7. The electric power transmission device according to claim 1, wherein the opening is provided in a surface of the magnetic core intersecting the axis of rotation.

8. The electric power transmission device according to claim 1, wherein the opening is provided in a surface of the magnetic core opposite to, in a radial direction to the axis of rotation, a surface thereof in which the through hole is provided.

9. A motor apparatus comprising:
a motor including a motor stator and a motor rotor, the motor stator including a first motor magnetic core and a first motor winding, the motor rotor including a second motor magnetic core and a second motor winding;
a shaft coupled to the motor rotor;
an inverter;
a magnetic core having a ring shape including a through hole through which the shaft extends, the magnetic core including therein a cavity along a circumferential direction about an axis of rotation of the shaft, and having an opening to the cavity, the opening being provided along the circumferential direction in a surface of the magnetic core different from a surface thereof in contact with the through hole;
a first winding coupled to the inverter, provided in the cavity, and wound along the circumferential direction;
a rotary member coupled to the shaft through the opening, the rotary member being rotationally movable, inside the cavity, in the circumferential direction with a rotation of the shaft;
a second winding provided on the rotary member and wound along the circumferential direction; and
a rectifying circuit provided in a path coupling the second winding and the second motor winding to each other.
